(19) United States
(12) Patent Application Publication
(10) Pub. No.: US 2023/0012165 A1
(43) Pub. Date: Jan. 12, 2023

(54) SEAMLESS PRINTING IN FUSED-FILAMENT FABRICATION OF ADDITIVE MANUFACTURING

(71) Applicant: Board of Regents, The University of Texas System, Austin, TX (US)

(72) Inventor: Cheng Luo, Arlington, TX (US)

(21) Appl. No.: 17/782,094

(22) PCT Filed: Dec. 3, 2020
(86) PCT No.: PCT/US2020/063028

§ 371 Date: Jun. 2, 2022

Related U.S. Application Data
(60) Provisional application No. 62/942,904, filed on Dec. 3, 2019.

(51) Int. Cl. B29C 64/118; B29C 64/209; B29C 64/245; B29C 64/336; B29C 64/295; B29C 64/393; B33Y 10/00; B33Y 30/00; B33Y 50/02

(52) U.S. Cl. CPC B29C 64/118; B29C 64/209; B29C 64/245; B29C 64/336; B29C 64/295; B29C 64/393; B33Y 10/00; B33Y 30/00; B33Y 50/02

(57) ABSTRACT

Various implementations include a three-dimensional printing device. The device includes a primary extruder, a secondary extruder, and a build plate. The primary extruder has a hollow primary body for accepting a printing material. An end of the primary body defines a primary extruder opening shaped to extrude a primary extrusion of melted printing material. The secondary extruder has a hollow secondary body for accepting a printing material. An end of the secondary body defines a secondary extruder opening shaped to extrude a secondary extrusion of melted printing material. A first primary extrusion extruded from the primary extruder disposed side by side with a second primary extrusion extruded from the primary extruder adjacent the build plate in a first layer defines a gap between adjacent edges of the first and second primary extrusions. A first secondary extrusion extruded from the secondary extruder is disposable in a second layer in the gap.

### BACKGROUND

Fused-filament fabrication (“FFF”), also known as fused deposition modeling and material extrusion based additive manufacturing (AM), is one of the most widely used processes in AM to fabricate three-dimensional (“3D”) polymer parts. The prior art FFF printer 100 shown in FIG. 1A includes a reel of solid filament 164 which is loaded into the printer. The solid filament 164 is then fed into an extruder 110 using two pinch wheels 142. The extruder 110 shown in FIG. 1B includes three main components: a long cylindrical tube 122 for liquefying a solid filament 164; a print nozzle 120 for extruding the molten filament 166; and a short conical tube 124 for connecting the cylindrical tube 122 and print nozzle 120. The cylindrical tube 122 is pre-heated by a surrounding heater 136 to a high temperature for melting the filament 164. This temperature is normally much higher than glass-transition temperature. The solid filament 164 is first molten inside the long cylindrical tube 122 of the extruder 110, and then extruded through the nozzle 120, followed by deposition on a build plate 150. The extruded filaments function as “printing ink.” They are stacked together to form a 3D polymer part, as shown in FIG. 1A.

When the FFF printer of the prior art extrudes the filaments in a pattern to form a part, the cross-sectional shape of the extruded filament can cause gaps to be formed between the extruded filaments. Gaps defined by the extruded filaments can cause the printed part to be structurally unstable since the coupling surface between adjacent extruded filaments is limited.

Thus, there is a desire for a FFF 3D printer capable of printing a part that does not include gaps between the extruded filaments.

### SUMMARY

Various implementations include a three-dimensional printing device. The device includes a primary extruder, a secondary extruder, and a build plate. The primary extruder has a hollow primary body for accepting a printing material. The primary body includes a first end and a second end opposite and spaced apart from the first end of the primary body. The second end of the primary body defines a primary extruder opening for extruding melted printing material. The primary extruder opening is shaped to extrude a primary extrusion having a cross-sectional shape in a plane perpendicular to a primary longitudinal axis.

The secondary extruder has a hollow secondary body for accepting a printing material. The secondary body includes a first end and a second end opposite and spaced apart from the first end of the secondary body. The second end of the secondary body defines a secondary extruder opening for extruding melted printing material. The secondary extruder opening is shaped to extrude a secondary extrusion having a cross-sectional shape in a plane perpendicular to a secondary longitudinal axis.

A first primary extrusion extruded from the primary extruder disposed side by side with a second primary extrusion extruded from the primary extruder adjacent the build plate in a first layer defines a gap between adjacent edges of the first and second primary extrusions. A first secondary extrusion extruded from the secondary extruder is disposable in a second layer in the gap.

In some implementations, the shape of the primary extruder opening and the shape of the secondary extruder opening are different.

In some implementations, the cross-sectional shape of the primary extrusion is a circle or oval.

In some implementations, the device further includes a primary material feeding device for introducing the printing material into the first end of the primary body of the primary extruder such that the printing material exits the primary extruder opening as melted printing material, and a secondary material feeding device for introducing the printing material into the first end of the secondary body of the secondary extruder such that the printing material exits the secondary extruder opening as melted printing material.

In some implementations, the primary extruder and the secondary extruder each include a heating device for melting the printing material into melted printing material.

In some implementations, the device further includes a computer numerical control (CNC) machine for moving the build plate, the primary extruder, and the secondary extruder relative to each other.

In some implementations, the printing material includes a polymer filament.

Various other implementations include a method of three-dimensional printing. The method includes providing a three-dimensional printing device, extruding the second primary extrusion disposed side by side with the first primary extrusion and adjacent the build plate in the first layer such that a first gap is defined between adjacent edges of the first and second primary extrusions, and extruding the first secondary extrusion such that the first secondary extrusion is disposed at least partially within the first gap. The three-dimensional printing device includes a primary extruder, a secondary extruder, and a build plate. The primary extruder has a hollow primary body for accepting a printing material. The primary body includes a first end and a second end opposite and spaced apart from the first end of the primary body. The second end of the primary body defines a primary extruder opening for extruding melted printing material. The primary extruder opening is shaped to extrude a primary extrusion having a cross-sectional shape in a plane perpendicular to a primary longitudinal axis.

The secondary extruder has a hollow secondary body for accepting a printing material. The secondary body includes a first end and a second end opposite and spaced apart from the first end of the secondary body. The second end of the secondary body defines a secondary extruder opening for extruding melted printing material. The secondary extruder opening is shaped to extrude a secondary extrusion having a cross-sectional shape in a plane perpendicular to a secondary longitudinal axis.

A first primary extrusion extruded from the primary extruder disposed side by side with a second primary extrusion extruded from the primary extruder adjacent the build plate in a first layer defines a gap between adjacent edges of the first and second primary extrusions. A first secondary extrusion extruded from the secondary extruder is disposable in a second layer in the gap.

In some implementations, the method further includes extruding a third primary extrusion adjacent the first primary extrusion in a second layer, and extruding a fourth primary extrusion disposed side by side with the third primary extrusion and adjacent the fourth primary extrusion in the second layer such that a second gap is defined between adjacent edges of the third and fourth primary extrusions. The first secondary extrusion is disposed at least partially within the second gap.

In some implementations, the method further includes extruding a third primary extrusion disposed side by side with the second primary extrusion and adjacent the build plate in the first layer such that a second gap is defined between adjacent edges of the second and third primary extrusions, and extruding a second secondary extrusion such that the second secondary extrusion is disposed at least partially within the second gap.

In some implementations, the shape of the primary extruder opening and the shape of the secondary extruder opening are different.

In some implementations, the cross-sectional shape of the primary extrusion is a circle or oval.

In some implementations, the device further includes a primary material feeding device for introducing the printing material into the first end of the primary body of the primary extruder such that the printing material exits the primary extruder opening as melted printing material, and a secondary material feeding device for introducing the printing material into the second end of the secondary body of the secondary extruder such that the printing material exits the secondary extruder opening as melted printing material.

In some implementations, the primary extruder and the secondary extruder each include a heating device for melting the printing material into melted printing material.

In some implementations, the device further comprises a computer numerical control (CNC) machine for moving the build plate, the primary extruder, and the secondary extruder relative to each other.

In some implementations, the printing material includes a polymer filament.

Various other implementations include a three-dimensional printing device. The device includes an extruder, a primary die head, a secondary die head, and a build plate. The extruder has a hollow body for accepting a printing material. The body includes a first end and a second end opposite and spaced apart from the first end of the body.

The primary die head defines a primary extruder opening for extruding melted printing material. The primary die head is removably couplable to the second end of the body. The primary extruder opening is shaped to extrude a primary extrusion having a cross-sectional shape in a plane perpendicular to a primary longitudinal axis.

The secondary die head defines a secondary extruder opening for extruding melted printing material. The secondary die head is removably couplable to the second end of the body. The secondary extruder opening is shaped to extrude a secondary extrusion having a cross-sectional shape in a plane perpendicular to a secondary longitudinal axis

A first primary extrusion extruded from the primary die head disposed side by side with a second primary extrusion extruded from the primary die head adjacent the build plate in a first layer defines a gap between adjacent edges of the first and second primary extrusions. A first secondary extrusion extruded from the secondary die head is disposable in a second layer in the gap.

The primary die head and the secondary die head are interchangeably couplable to the second end of the body.

In some implementations, the shape of the primary extruder opening and the shape of the secondary extruder opening are different.

In some implementations, the cross-sectional shape of the primary extrusion is a circle or oval.

In some implementations, the device further includes a material feeding device for introducing the printing material into the first end of the body of the extruder such that the printing material exits the second end of the extruder as melted printing material.

In some implementations, the extruder includes a heating device for melting the printing material into melted printing material.

In some implementations, the device further includes a computer numerical control (CNC) machine for moving the build plate and the extruder relative to each other.

In some implementations, the printing material includes a polymer filament.

### BRIEF DESCRIPTION OF DRAWINGS

Example features and implementations are disclosed in the accompanying drawings. However, the present disclosure is not limited to the precise arrangements and instrumentalities shown. Similar elements in different implementations are designated using the same reference numerals.

FIG. 1A is a side view of a 3D printer of the prior art.

FIG. 1B is a side view of the extruder of the 3D printer of FIG. 1A.

FIG. 1C is an end view of extruded filaments extruded by the 3D printer of FIG. 1A.

FIG. 2 is a side view of a 3D printing device, according to one implementation.

FIGS. 3A-3G are end views of extrusions extruded by the 3D printing device of FIG. 2.

FIG. 4 is a side view of a 3D printing device, according to another implementation.

### DETAILED DESCRIPTION

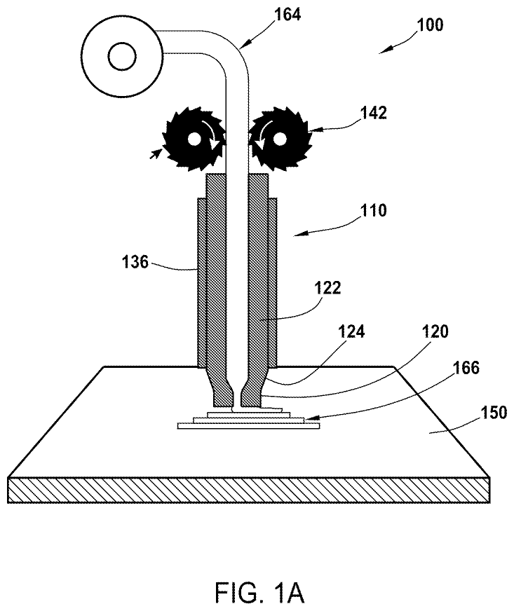

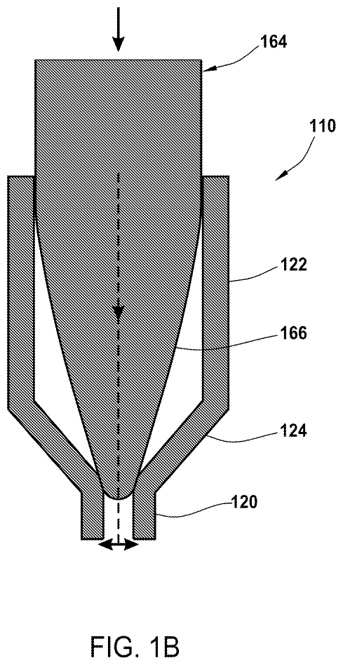

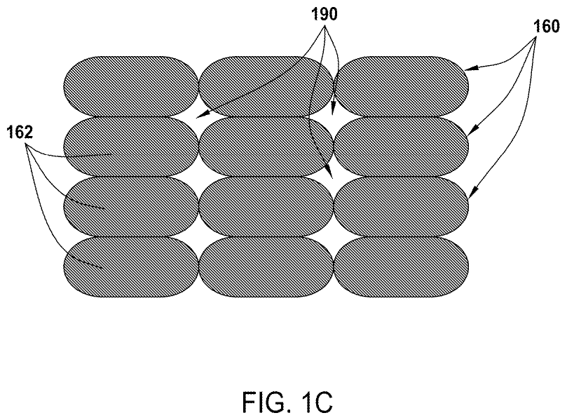

When printing an object using a fused-filament fabrication (“FFF”) 3D printer 100 of the prior art, gaps 190 are defined within the printed object due to the cross-sectional shape 162 of the individual extrusions 160, as shown in FIG. 1C. The devices, systems, and methods disclosed herein provide for a three-dimensional printing device capable of extruding secondary extrusions to fill the gaps between primary extrusions when 3D printing a part. The secondary extruder opening is shaped to extrude a secondary extrusion having a cross-sectional shape designed to fill the gap between the primary extrusions.

In some implementations, the device includes a reservoir for accepting melted printing material and maintaining the printing material in a melted state. In other implementations, the device includes a melting system for accepting solid printing material and converting the solid printing material into a melted state. Because the devices, systems, and methods disclosed herein accept melted printing material instead of melting the solid printing material as the device feeds the solid printing material through the extruder, the device is less likely to malfunction due to the melting speed being slower than the feed rate.

Various implementations include a three-dimensional printing device. The device includes a primary extruder, a secondary extruder, and a build plate. The primary extruder has a hollow primary body for accepting a printing material. The primary body includes a first end and a second end opposite and spaced apart from the first end of the primary body. The second end of the primary body defines a primary extruder opening for extruding melted printing material. The primary extruder opening is shaped to extrude a primary extrusion having a cross-sectional shape in a plane perpendicular to a primary longitudinal axis.

The secondary extruder has a hollow secondary body for accepting a printing material. The secondary body includes a first end and a second end opposite and spaced apart from the first end of the secondary body. The second end of the secondary body defines a secondary extruder opening for extruding melted printing material. The secondary extruder opening is shaped to extrude a secondary extrusion having a cross-sectional shape in a plane perpendicular to a secondary longitudinal axis.

A first primary extrusion extruded from the primary extruder disposed side by side with a second primary extrusion extruded from the primary extruder adjacent the build plate in a first layer defines a gap between adjacent edges of the first and second primary extrusions. A first secondary extrusion extruded from the secondary extruder is disposable in a second layer in the gap.

Various other implementations include a method of three-dimensional printing. The method includes providing a three-dimensional printing device, extruding the second primary extrusion disposed side by side with the first primary extrusion and adjacent the build plate in the first layer such that a first gap is defined between adjacent edges of the first and second primary extrusions, and extruding the first secondary extrusion such that the first secondary extrusion is disposed at least partially within the first gap. The three-dimensional printing device includes a primary extruder, a secondary extruder, and a build plate. The primary extruder has a hollow primary body for accepting a printing material. The primary body includes a first end and a second end opposite and spaced apart from the first end of the primary body. The second end of the primary body defines a primary extruder opening for extruding melted printing material. The primary extruder opening is shaped to extrude a primary extrusion having a cross-sectional shape in a plane perpendicular to a primary longitudinal axis.

The secondary extruder has a hollow secondary body for accepting a printing material. The secondary body includes a first end and a second end opposite and spaced apart from the first end of the secondary body. The second end of the secondary body defines a secondary extruder opening for extruding melted printing material. The secondary extruder opening is shaped to extrude a secondary extrusion having a cross-sectional shape in a plane perpendicular to a secondary longitudinal axis.

A first primary extrusion extruded from the primary extruder disposed side by side with a second primary extrusion extruded from the primary extruder adjacent the build plate in a first layer defines a gap between adjacent edges of the first and second primary extrusions. A first secondary extrusion extruded from the secondary extruder is disposable in a second layer in the gap.

Various other implementations include a three-dimensional printing device. The device includes an extruder, a primary die head, a secondary die head, and a build plate. The extruder has a hollow body for accepting a printing material. The body includes a first end and a second end opposite and spaced apart from the first end of the body.

The primary die head defines a primary extruder opening for extruding melted printing material. The primary die head is removably couplable to the second end of the body. The primary extruder opening is shaped to extrude a primary extrusion having a cross-sectional shape in a plane perpendicular to a primary longitudinal axis.

The secondary die head defines a secondary extruder opening for extruding melted printing material. The secondary die head is removably couplable to the second end of the body. The secondary extruder opening is shaped to extrude a secondary extrusion having a cross-sectional shape in a plane perpendicular to a secondary longitudinal axis

A first primary extrusion extruded from the primary die head disposed side by side with a second primary extrusion extruded from the primary die head adjacent the build plate in a first layer defines a gap between adjacent edges of the first and second primary extrusions. A first secondary extrusion extruded from the secondary die head is disposable in a second layer in the gap.

The primary die head and the secondary die head are interchangeably couplable to the second end of the body.

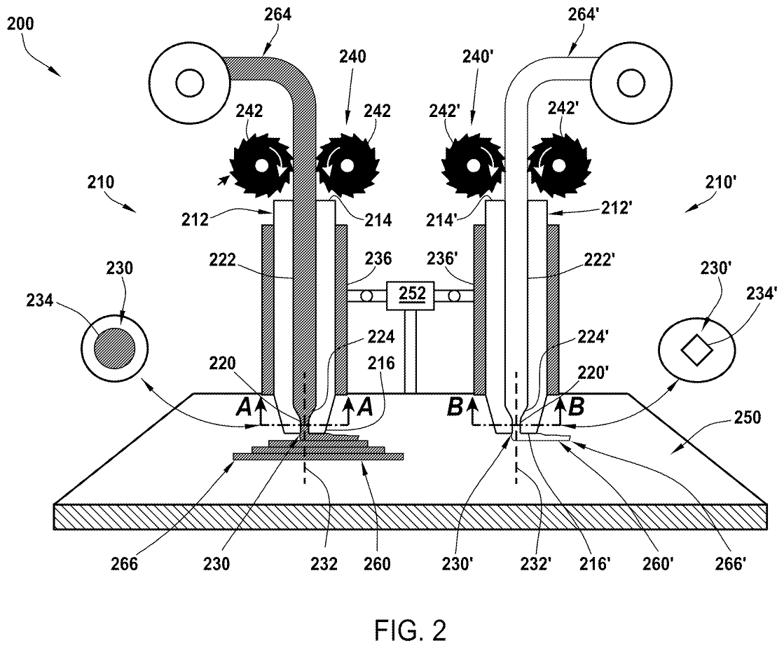

FIG. 2 shows a three-dimensional printing device 200. The device 200 includes a primary extruder 210, a secondary extruder 210′, a primary material feeding device 240, a secondary material feeding device 240′, a build plate 250, and a computer numerical control (“CNC”) machine 252.

The primary extruder 210 has a hollow primary body 212 for accepting a printing material 264. The primary body 212 has a first end 214 and a second end 216 opposite and spaced apart from the first end 214 of the primary body 212. The primary body 212 includes a print nozzle 220 proximal to the second end 216 of the primary extruder 210, a cylindrical portion 222 proximal the first end 214 of the primary extruder 210, and a short conical portion 224 for coupling the print nozzle 220 to the cylindrical portion 222.

The second end 216 of the primary body 212 defines a primary extruder opening 230 for extruding melted printing material 266. The primary extruder opening 230 has a cross-sectional shape 234 in a plane perpendicular to a primary longitudinal axis 232 of the primary extruder 210. The cross-sectional shape 234 of the primary extruder opening 230 is shaped to extrude a primary extrusion 260 having a cross-sectional shape 262 in the plane perpendicular to a primary longitudinal axis 232.

The primary extruder 210 includes a primary extruder heating device 236 surrounding the primary body 212. The primary extruder heating device 236 is configured to provide enough heat to the solid printing material 264 within the primary extruder 210 to melt the printing material 264 into a liquid state. The primary extruder heating device 236 shown in FIG. 2 is an electric resistance heating device, but in other implementations, the primary extruder heating device is any other device capable of creating enough heat to maintain the melted printing material within the primary extruder in a liquid state.

The secondary extruder 210′ has a hollow secondary body 212′ for accepting a solid printing material 264′. The secondary body 212′ has a first end 214′ and a second end 216′ opposite and spaced apart from the first end 214′ of the secondary body 212′. The secondary body 212′ includes a print nozzle 220′ proximal to the second end 216′ of the secondary extruder 210′, a cylindrical portion 222′ proximal the first end 214′ of the secondary extruder 210′, and a short conical portion 224′ for coupling the print nozzle 220′ to the cylindrical portion 222′.

The second end 216′ of the secondary body 212′ defines a secondary extruder opening 230′ for extruding melted printing material 266′. The secondary extruder opening 230′ has a cross-sectional shape 234′ in a plane perpendicular to a secondary longitudinal axis 232′ of the secondary extruder 210′. The cross-sectional shape 234′ of the secondary extruder opening 230′ is shaped to extrude a secondary extrusion 260′ having a cross-sectional shape 262′ in the plane perpendicular to a secondary longitudinal axis 232′.

The secondary extruder 210′ includes a secondary extruder heating device 236′ surrounding the secondary body 212′. The secondary extruder heating device 236′ is configured to provide enough heat to melted printing material 266′ within the secondary extruder 210′ to maintain the melted printing material 266′ in a liquid state. The secondary extruder heating device 236′ shown in FIG. 2 is an electric resistance heating device, but in other implementations, the secondary extruder heating device is any other device capable of creating enough heat to maintain the melted printing material within the secondary extruder in a liquid state.

The printing material 264, 264′ used in both the primary extruder 210 and the secondary extruder 210′ shown in FIG. 2 is a polymer melt such as acrylonitrile butadiene styrene (ABS), polylactide (PLA), or polycaprolactone (PCL), but in other implementations, the printing material is any material capable of being melted, extruded through the primary extruder and/or the secondary extruder and onto the build plate, and then being solidified. In FIG. 2, the printing material 264 being extruded through the primary extruder 210 is the same material as the printing material 264′ being extruded through the secondary extruder 210′, but in other implementations, the printing material being extruded through the primary extruder and the secondary extruder can be different materials.

The primary material feeding device 240 includes two gears 242 with interlocking teeth for feeding solid printing material 264 into the first end 214 of the primary extruder 210 such that the solid printing material 264 exits the primary extruder opening 230 in a liquid state. As the gears 242 turn, the teeth of each gear 242 engage a portion of the solid printing material 264 and transfer the solid printing material 264 toward the first end 214 of the primary extruder 210. Because the gears 242 turn in a single direction and at a constant rate, the primary material feeding device 240 introduces the printing material 264 into the first end 214 of the primary extruder 210 and causes the melted printing material 266 to exit the second end 216 of the primary extruder 210 at a constant rate.

The secondary material feeding device 240′ includes two gears 242′ with interlocking teeth for feeding solid printing material 264′ into the first end 214′ of the secondary extruder 210′ such that the solid printing material 264′ exits the secondary extruder opening 230′ in a liquid state. As the gears 242′ turn, the teeth of each gear 242′ engage a portion of the solid printing material 264′ and transfer the solid printing material 264′ toward the first end 214′ of the secondary extruder 210′. Because the gears 242′ turn in a single direction and at a constant rate, the secondary material feeding device 240′ introduces the printing material 264′ into the first end 214′ of the secondary extruder 210′ and causes the melted printing material 266′ to exit the second end 216′ of the secondary extruder 210′ at a constant rate.

The build plate 250 is disposed adjacent the second end 216 of the primary extruder 210 and the second end 216′ of the secondary extruder 210′. The build plate 250 includes a flat surface onto which melted printing material 266 is deposited as it flows from the second end 216 of the primary extruder 210 and onto which melted printing material 266′ is deposited as it flows from the second end 216′ of the secondary extruder 210′.

The CNC machine 252 is coupled to the primary extruder 210 and the secondary extruder 210′. The CNC machine 252 is able to move the primary extruder 210 and secondary extruder 210′ in X-, Y-, and Z-axes relative to the build plate 250 such that the melted printing material 266 flowing from the second end 216 of the primary extruder 210 and the melted printing material 266′ flowing from the second end 216′ of the secondary extruder 210′ can be deposited on the build plate 250 in lines. The melted printing material 266, 266′ can then solidify to form the desired manufactured part.

As shown in FIG. 2, the shape of the primary extruder opening 230 and the shape of the secondary extruder opening 230′ are different, as shown by cross-sectional lines A-A and B-B in FIG. 2. The primary extruder opening 230 is shaped to produce a primary extrusion 260 having a circular or oval cross-sectional shape 262, but in other implementations, the primary extruder opening is shaped to produce any cross-sectional shape desired. Although the shapes of the primary and secondary extruder openings 230, 230′ shown in FIG. 2 are different, in other implementations, the shapes of the primary and secondary extruder openings are the same.

Because the distance between the second end 216 of the primary extruder 210 and the build plate 250 is less than the diameter of the cross-sectional shape 262 of the primary extrusion 260 exiting the primary extruder opening 230, the melted printing material 266 is pressed against the build plate 250 by the primary extruder 210. The pressing of the melted printing material 266 against the build plate 250 by the primary extruder 210 changes the cross-sectional shape 262 of the primary extrusion 260 to have a flattened side adjacent the build plate 250 and a flattened side adjacent opposite the build plate 250.

The shapes of the primary extruder opening 230 and secondary extruder opening 230′ are configured to be complementary to each other, as shown by cross-sectional lines A-A and B-B in FIG. 2. When two primary extrusions 260 are extruded from the primary extruder 210 disposed side by side with each other, a gap 290 is defined between adjacent edges of the two primary extrusions 260. The secondary extruder opening 230′ is cross-sectionally shaped 262′ to form a secondary extrusion 260′ that fills the gap 290 between the adjacent primary extrusions 260. The secondary extrusion 260′ can also be cross-sectionally shaped 262′ to extend out of the gap 290 to fill another adjacent gap 290 defined by other adjacent primary extrusions 260.

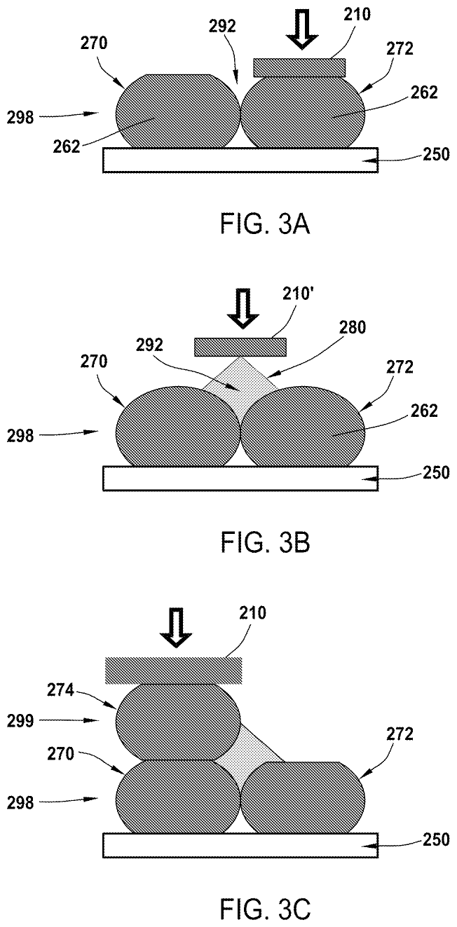

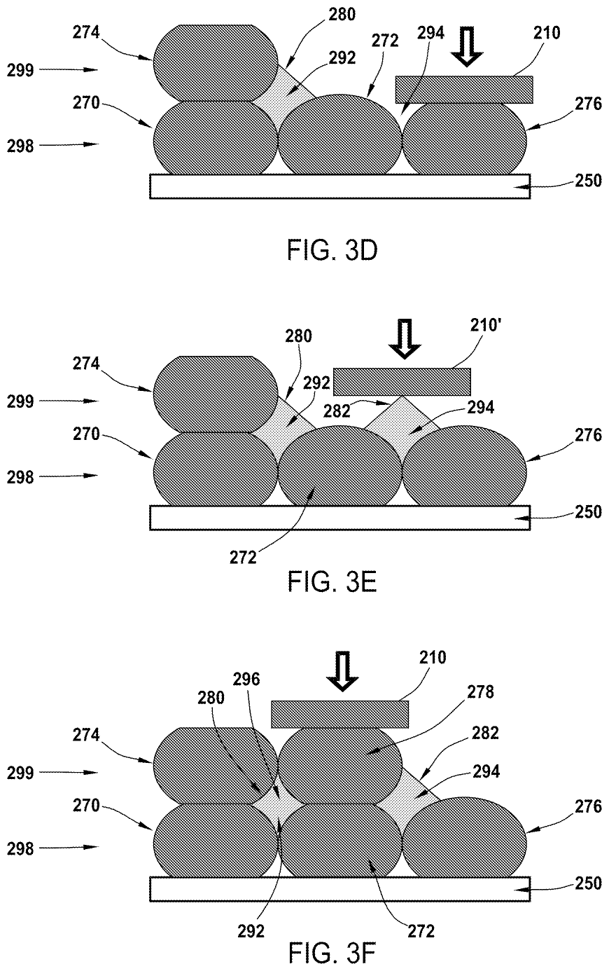

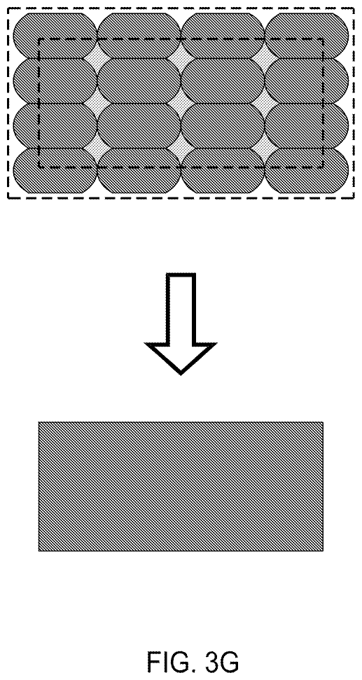

In use, a first primary extrusion 270 is extruded from the primary extruder 210 onto the build plate 250, and a second primary extrusion 272 is extruded from the primary extruder 210 side by side in a horizontal axis with the first primary extrusion 270 in a first layer 298, as shown in FIG. 3A. A first gap 292 is defined between adjacent edges of the first and second primary extrusions 270, 272. A first secondary extrusion 280 is then extruded from the secondary extruder 210′ such that the first secondary extrusion 280 is disposed partially within in the first gap 292 formed between the first and second primary extrusions 270, 272, as shown in FIG. 3B.

FIG. 3C shows a third primary extrusion 274 extruded from the primary extruder 210 adjacent the first primary extrusion 270 in a vertical direction to form a second layer 299. As shown in FIG. 3D, a fourth primary extrusion 276 can then be extruded from the primary extruder 210 onto the build plate 250 horizontally side by side with the second primary extrusion 272 in the first layer 298 to define a second gap 294 between adjacent edges of the second and fourth primary extrusions 272, 276. FIG. 3E shows a second secondary extrusion 282 being extruded from the secondary extruder 210′ such that the second secondary extrusion 282 is disposed partially within in the second gap 294 formed between the second and fourth primary extrusions 272, 276. A fifth primary extrusion 278 can be extruded from the primary extruder 210 vertically adjacent to the second primary extrusion 272 and horizontally adjacent to the third primary extrusion 274 in the second layer 299 to define a third gap 296 between adjacent edges of the third and fifth primary extrusions 274, 278, as shown in FIG. 3F. The third gap 296 is defined such that the first secondary extrusion 280 is disposed within the second gap 294.

This process can be repeated to form any part by extruding any number of primary extrusions 260 in the horizontal and vertical directions with secondary extrusions disposed within the gaps 290 defined between adjacent edges of the primary extrusions 260. Once the finished part is completed, the part can be polished to remove any exterior facing gaps 290 formed between the primary extrusions 260 that do not have secondary extrusions 260′ disposed within them, as shown in FIG. 3G.

The above described method of using the devices disclosed herein is not limited to any particular order or pattern of extruding primary extrusions 260 and secondary extrusions 260′. For example, although the above method describes alternating between extruding primary and secondary extrusions 260, 260′, in some implementations, all of the primary extrusions in a single layer are extruded first, then secondary extrusions are extruded within the gaps defined between horizontally adjacent primary extrusions before another vertically adjacent layer of primary extrusions are extruded.

The terms “horizontal” and “horizontal direction” are used herein to refer to extrusions 260, 260′ disposed within the same layer 298, 299 and do not restrict the arrangement of the extrusions 260, 260′ in a single direction. In some implementations, the extrusions are not disposed in straight lines and, thus, horizontally adjacent extrusions are not arranged in a straight line. The terms “vertical” and “vertical direction” are used herein to refer to extrusions 260, 260′ disposed adjacently in different layers 298, 299 and do not restrict the arrangement of the extrusions 260, 260′ in a single direction. In some implementations, adjacent extrusions in different layers are disposed offset from each other and, thus, vertically adjacent extrusions are not arranged in directly above each other.

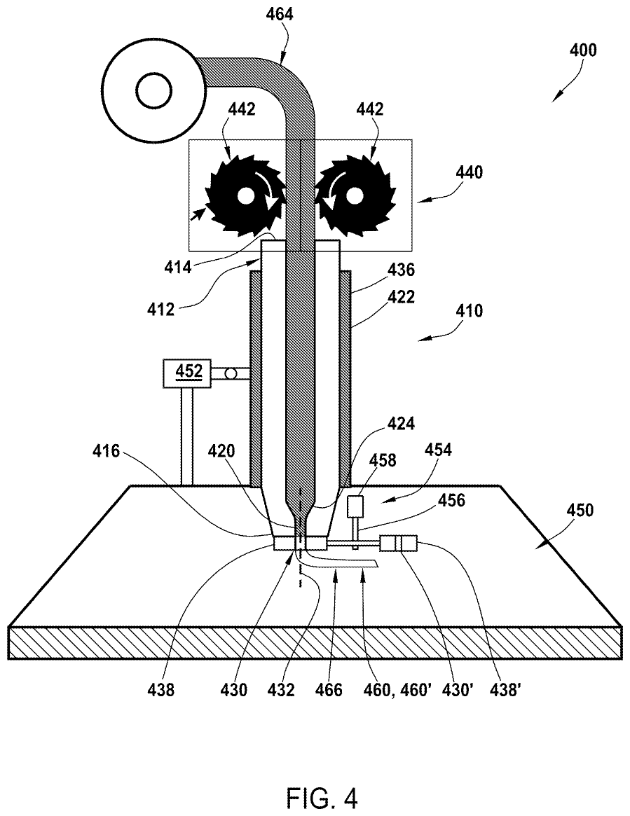

FIG. 4 shows another implementation of a three-dimensional printing device 400. The device 400 shown in FIG. 4 has a build plate 450 and a CNC machine 452 like the device 200 shown in FIG. 2, but the device 400 shown in FIG. 4 only has a single extruder 410 and a single material feeding device 440. The extruder 410 is similar to the extruders 210, 210′ shown in FIG. 2, but the extruder 410 shown in FIG. 4 includes a removably couplable primary die head 438 and a removably couplable secondary die head 438′. The extruder 410, build plate 450, and CNC machine 452 of the device 400 shown in FIG. 4 are similar to the extruders 210, 210′, build plate 250, and CNC machine 252 of the device 200 shown in FIG. 2, and thus, features of the extruder 410, build plate 450, and CNC machine 452 of device 400 are indicated using similar reference numbers.

The primary die head 438 defines a primary extruder opening 430 for extruding melted printing material 466. The primary die head 438 is removably couplable to the second end 416 of the body of the extruder 410. Like the primary extruder opening 230 of the primary extruder 220 shown in FIG. 2, the primary extruder opening 430 shown in FIG. 4 has a cross-sectional shape 434 for extruding a primary extrusion 460 having a cross-sectional shape 462 in a plane perpendicular to a longitudinal axis 432.

The secondary die head 438′ defines a secondary extruder opening 430′ for extruding melted printing material 466. The secondary die head 438′ is removably couplable to the second end 416 of the body of the extruder 410. Like the secondary extruder opening 230′ of the secondary extruder 220′ shown in FIG. 2, the secondary extruder opening 430′ shown in FIG. 4 has a cross-sectional shape 434′ for extruding a secondary extrusion 460′ having a cross-sectional shape 462′ in a plane perpendicular to the longitudinal axis 432.

The extruder 410 includes an extruder heating device 436 surrounding the body 412. The extruder heating device 436 is configured to provide enough heat to the solid printing material 464 within the extruder 410 to melt the printing material 464 in a liquid state. The extruder heating device 436 shown in FIG. 4 is an electric resistance heating device, but in other implementations, the extruder heating device is any other device capable of creating enough heat to maintain the melted printing material within the extruder in a liquid state.

The material feeding device 440 includes two gears 442 with interlocking teeth for feeding solid printing material 464 into the first end 414 of the extruder 410 such that the solid printing material 464 exits the extruder 410 in a liquid state. As the gears 442 turn, the teeth of each gear 442 engage a portion of the solid printing material 464 and transfer the solid printing material 464 toward the first end 414 of the extruder 410. Because the gears 442 turn in a single direction and at a constant rate, the material feeding device 440 introduces the printing material 464 into the first end 414 of the extruder 410 and causes the melted printing material 466 to exit the second end 416 of the extruder 410 at a constant rate.

The CNC machine 452 shown in FIG. 4 further includes a die head changing device 454 for uncoupling one of the primary or secondary die heads 438, 438′ from the second end 416 of the extruder 410 and coupling the other of the primary or secondary die heads 438, 438′ to the second end 416 of the extruder 410. Thus, the extruder 410 can extrude a primary extrusion 460 through the primary die head 438, the die head changing device 454 can exchange the primary die head 438 from the extruder 410 with the secondary die head 438′, and then the extruder 410 can extrude a secondary 460′ extrusion through the secondary die head 438′. The die head changing device 454 includes an axle 456 and a motor 458 coupled to the axle 456. The die heads 438, 438′ are radially coupled to the axle 456. The motor 458 rotates the axle 456 and die heads 438, 438′ to couple a desired die head 438, 438′ to the second end 416 of the extruder 410. Although the die head changing device 454 shown in FIG. 4 includes an axle 456 and a motor 458 coupled to the axle 456, in other implementations, the die head changing device is any device capable of decoupling one die head from the second end of the extruder and coupling another die head to the second end of the extruder. Although the device 400 and die head changing device 454 shown in FIG. 4 includes primary and secondary die heads 438, 438′, in other implementations, the device and die head changing device include three or more removably couplable die heads that can be interchanged on the second end of the extruder.

The device 400 shown in FIG. 4 can be used in the same ways as the device 200 shown in FIG. 2 by interchanging the die head 438, 438′ coupled to the second end 416 of the extruder 410 to form primary and secondary extrusions 460, 460′, rather than by using two separate extruders 210, 210′ as described with respect to FIGS. 3A-3G.

A number of implementations have been described. Nevertheless, it will be understood that various modifications may be made without departing from the spirit and scope of the claims. Accordingly, other implementations are within the scope of the following claims.

Certain terminology is used herein for convenience only and is not to be taken as a limitation on the present claims. In the drawings, the same reference numbers are employed for designating the same elements throughout the several figures. A number of examples are provided, nevertheless, it will be understood that various modifications can be made without departing from the spirit and scope of the disclosure herein. As used in the specification, and in the appended claims, the singular forms “a,” “an,” “the” include plural referents unless the context clearly dictates otherwise. The term “comprising” and variations thereof as used herein is used synonymously with the term “including” and variations thereof and are open, non-limiting terms. Although the terms “comprising” and “including” have been used herein to describe various implementations, the terms “consisting essentially of” and “consisting of” can be used in place of “comprising” and “including” to provide for more specific implementations and are also disclosed.

1. A three-dimensional printing device, the device comprising:
a primary extruder having a hollow primary body for accepting a printing material, the primary body including a first end and a second end opposite and spaced apart from the first end of the primary body, wherein the second end of the primary body defines a primary extruder opening for extruding melted printing material, wherein the primary extruder opening is shaped to extrude a primary extrusion having a cross-sectional shape in a plane perpendicular to a primary longitudinal axis;
a secondary extruder having a hollow secondary body for accepting a printing material, the secondary body including a first end and a second end opposite and spaced apart from the first end of the secondary body, wherein the second end of the secondary body defines a secondary extruder opening for extruding melted printing material, wherein the secondary extruder opening is shaped to extrude a secondary extrusion having a cross-sectional shape in a plane perpendicular to a secondary longitudinal axis; and
a build plate,
wherein a first primary extrusion extruded from the primary extruder disposed side by side with a second primary extrusion extruded from the primary extruder adjacent the build plate in a first layer defines a gap between adjacent edges of the first and second primary extrusions, and a first secondary extrusion extruded from the secondary extruder is disposable in a second layer in the gap.

2. The device of claim 1, wherein the shape of the primary extruder opening and the shape of the secondary extruder opening are different.

3. The device of claim 1, wherein the cross-sectional shape of the primary extrusion is a circle or oval.

4. The device of claim 1, further comprising a primary material feeding device for introducing the printing material into the first end of the primary body of the primary extruder such that the printing material exits the primary extruder opening as melted printing material, and a secondary material feeding device for introducing the printing material into the first end of the secondary body of the secondary extruder such that the printing material exits the secondary extruder opening as melted printing material.

5. The device of claim 1, wherein the primary extruder and the secondary extruder each include a heating device for melting the printing material into melted printing material.

6. The device of claim 1, further comprising a computer numerical control (CNC) machine for moving the build plate, the primary extruder, and the secondary extruder relative to each other.

7. (canceled)

8. A method of three-dimensional printing, the method comprising:
providing a three-dimensional printing device, the device comprising:
a primary extruder having a hollow primary body for accepting a printing material, the primary body including a first end and a second end opposite and spaced apart from the first end of the primary body, wherein the second end of the primary body defines a primary extruder opening for extruding melted printing material, wherein the primary extruder opening is shaped to extrude a primary extrusion having a cross-sectional shape in a plane perpendicular to a primary longitudinal axis,
a secondary extruder having a hollow secondary body for accepting a printing material, the secondary body including a first end and a second end opposite and spaced apart from the first end of the secondary body, wherein the second end of the secondary body defines a secondary extruder opening for extruding melted printing material, wherein the secondary extruder opening is shaped to extrude a secondary extrusion having a cross-sectional shape in a plane perpendicular to a secondary longitudinal axis, and
a build plate,
wherein a first primary extrusion extruded from the primary extruder disposed side by side with a second primary extrusion extruded from the primary extruder adjacent the build plate in a first layer defines a gap between adjacent edges of the first and second primary extrusions, and a first secondary extrusion extruded from the secondary extruder is disposable in a second layer in the gap;
extruding the first primary extrusion adjacent the build plate in the first layer;
extruding the second primary extrusion disposed side by side with the first primary extrusion and adjacent the build plate in the first layer such that a first gap is defined between adjacent edges of the first and second primary extrusions; and
extruding the first secondary extrusion such that the first secondary extrusion is disposed at least partially within the first gap.

9. The method of claim 8, further comprising:
extruding a third primary extrusion adjacent the first primary extrusion in a second layer; and
extruding a fourth primary extrusion disposed side by side with the third primary extrusion and adjacent the fourth primary extrusion in the second layer such that a second gap is defined between adjacent edges of the third and fourth primary extrusions, wherein the first secondary extrusion is disposed at least partially within the second gap.

10. The method of claim 8, further comprising:
extruding a third primary extrusion disposed side by side with the second primary extrusion and adjacent the build plate in the first layer such that a second gap is defined between adjacent edges of the second and third primary extrusions; and
extruding a second secondary extrusion such that the second secondary extrusion is disposed at least partially within the second gap.

11. The method of claim 8, wherein the shape of the primary extruder opening and the shape of the secondary extruder opening are different.

12. The method of claim 8, wherein the cross-sectional shape of the primary extrusion is a circle or oval.

13. The method of claim 8, wherein the device further comprises a primary material feeding device for introducing the printing material into the first end of the primary body of the primary extruder such that the printing material exits the primary extruder opening as melted printing material, and a secondary material feeding device for introducing the printing material into the second end of the secondary body of the secondary extruder such that the printing material exits the secondary extruder opening as melted printing material.

14. The method of claim 8, wherein the primary extruder and the secondary extruder each include a heating device for melting the printing material into melted printing material.

15. The method of claim 8, wherein the device further comprises a computer numerical control (CNC) machine for moving the build plate, the primary extruder, and the secondary extruder relative to each other.

16. (canceled)

17. A three-dimensional printing device, the device comprising:
an extruder having a hollow body for accepting a printing material, the body including a first end and a second end opposite and spaced apart from the first end of the body;
a primary die head defining a primary extruder opening for extruding melted printing material, the primary die head being removably couplable to the second end of the body, wherein the primary extruder opening is shaped to extrude a primary extrusion having a cross-sectional shape in a plane perpendicular to a primary longitudinal axis;
a secondary die head defining a secondary extruder opening for extruding melted printing material, the secondary die head being removably couplable to the second end of the body, wherein the secondary extruder opening is shaped to extrude a secondary extrusion having a cross-sectional shape in a plane perpendicular to a secondary longitudinal axis; and
a build plate,
wherein a first primary extrusion extruded from the primary die head disposed side by side with a second primary extrusion extruded from the primary die head adjacent the build plate in a first layer defines a gap between adjacent edges of the first and second primary extrusions, and a first secondary extrusion extruded from the secondary die head is disposable in a second layer in the gap, and
wherein the primary die head and the secondary die head are interchangeably couplable to the second end of the body.

18. The device of claim 17, wherein the shape of the primary extruder opening and the shape of the secondary extruder opening are different.

19. The device of claim 17, wherein the cross-sectional shape of the primary extrusion is a circle or oval.

20. The device of claim 17, further comprising a material feeding device for introducing the printing material into the first end of the body of the extruder such that the printing material exits the second end of the extruder as melted printing material.

21. The device of claim 17, wherein the extruder includes a heating device for melting the printing material into melted printing material.

22. The device of claim 17, further comprising a computer numerical control (CNC) machine for moving the build plate and the extruder relative to each other.

23. (canceled)
